(19) United States
(12) Patent Application Publication
(10) Pub. No.: US 2016/0210635 A1
(43) Pub. Date: Jul. 21, 2016

(54) SECOND-DEVICE TRANSACTION VERIFICATION AND APPROVAL

(71) Applicant: Taply, Inc., New York, NY (US)

(72) Inventor: Benjamin Alyeshmerni, Muttontown, NY (US)

(21) Appl. No.: 14/954,009

(22) Filed: Nov. 30, 2015

Related U.S. Application Data
(60) Provisional application No. 62/105,502, filed on Jan. 20, 2015.

(51) Int. Cl. G06Q 20/40; G06Q 20/32; G06Q 20/38

(52) U.S. Cl. CPC G06Q 20/40145; G06Q 20/382; G06Q 20/322

(57) ABSTRACT

In one embodiment, a method for a payment application web server includes (1) allowing a user to (a) select, using a first device, a set of items for purchase from a merchant and select to pay the merchant using a hub-operator service, (2) receiving from the first device, first information including a unique identifier associated with a mobile device and the user (3) providing to the mobile device, using the unique identifier, second information identifying the set of items, the merchant, and a transaction to pay the merchant for the set of items using the hub operator, (4) prompting the user to approve the transaction using the mobile device, (5) providing to a payment-system back-end, third information identifying the transaction, for authorization of the transaction by the payment-system back-end, and (6) providing notification of the authorization of the transaction to the mobile device, the first device, and the merchant.

This application claims the benefit of the filing date of U.S. Provisional Application No. 62/105,502 filed on Jan. 20, 2015, the teachings of which are incorporated herein by reference in their entirety.

### BACKGROUND

The current invention relates to systems and methods for securely performing an e-commerce transaction and specifically, although not exclusively, to a transaction completed on a mobile device.

Electronic commerce, or e-commerce, refers generally to commercial transactions performed using computer networks, such as the Internet. A typical e-commerce transaction involves a customer visiting a merchant's website on the Web, selecting one or more items to purchase, and providing payment and shipping information for the purchased items. The payment information is typically verified by a third-party financial-services provider that verifies that the provided payment source—such as, for example, a debit or credit account—is valid. Upon successful verification, confirmation is provided to the merchant who, in turn, confirms the purchase transaction to the customer and obtains the funds from the payment source to pay for the purchase. The merchant then proceeds to process the order and arrange for shipping of the purchased items.

For a variety of reasons—such as, for example, concerns about identity theft and credit-card fraud—many consumers prefer to use alternative payment methods that allow consumers to pay for purchased items without providing their credit or debit card information to the merchants. One such alternative payment method is using a digital wallet service, such as, for example, PayPal (from PayPal of San Jose, Calif.) or Google Wallet (from Google, of Mountain View, Calif.). These digital wallet services function as trusted intermediaries between consumers and merchants that have the relevant financial information for consumer and merchants and thereby allowing consumers to pay merchants without providing the consumers' financial information to the merchants. Additional alternative systems and methods for e-commerce transactions may provide additional benefits to consumers, such as additional convenience and/or security checks to verify the authenticity of the user and the transaction.

### SUMMARY

One embodiment of the disclosure can be a method for a payment application web server. The method comprises (1) allowing a user to select, using a first computer device, a set of one or more items for purchase from a merchant, (2) allowing the user to select, using the first computer device, to pay the merchant using a hub-operator service associated with the payment application web server, (3) receiving, by the payment application web server, first information identifying the set of one or more items, the merchant, and a unique identifier associated with the user, (4) providing, by the payment application web server, to a mobile device of the user, using the unique identifier, second information identifying the set of one or more items, the merchant, and a transaction to pay the merchant for the set of one or more items using the hub-operator service, (5) prompting the user to approve the transaction using the mobile device, (6) providing, by the payment application web server, to a payment system back-end, third information identifying the transaction, for authorization of the transaction by the payment system back-end, and (7) providing, by the payment application web server, notification of the authorization of the transaction to the mobile device, the computer, and the merchant.

### BRIEF DESCRIPTION OF THE DRAWINGS

Other embodiments of the invention will become apparent. In the accompanying drawings, like reference numerals identify similar or identical elements.

FIG. 1 is a simplified block diagram of a system in accordance with one exemplary embodiment of the invention.

FIG. 2 is a flowchart of an exemplary procedure for using the system of FIG. 1.

FIG. 3A is a screenshot of the computer of FIG. 1 during checkout from the merchant website.

FIG. 3B is a screenshot of the computer after the user selected to pay using the hub-operator's service.

FIG. 3C is a screenshot of the computer after the user entered the mobile device's number.

FIG. 3D is a screenshot of the computer after the user affirmed the mobile-device number.

FIG. 3E is a screenshot of the mobile device of FIG. 1 after the user received a notification of the order placed through the merchant's website.

FIG. 3F is a screenshot of the mobile device after the user selected the notification of FIG. 3E.

FIG. 3G is a screenshot of the mobile device after the user approved the transaction by selecting the approval button of FIG. 3F.

FIG. 3H is a screenshot of the mobile device after the user selected an option of FIG. 3G and successfully passed fingerprint verification.

FIG. 3I is a screenshot of the mobile device after the payment has been authorized.

FIG. 3J is a screenshot of the computer after the payment has been authorized.

FIG. 3K is a screenshot of the computer after a confirmation email has been sent to the user.

### DETAILED DESCRIPTION

In one embodiment of the invention, a system and method are provided for securely performing an e-commerce transaction (e.g., a payment) initiated by a user using a first device (e.g., a desktop or laptop computer), to which the user provides an identifier (e.g., a telephone number or email address) for a second device that permits completion of the transaction on the second device (e.g., a mobile telephone device) that executes an application using one or more (e.g., biometric) techniques to verify the identity of the user.

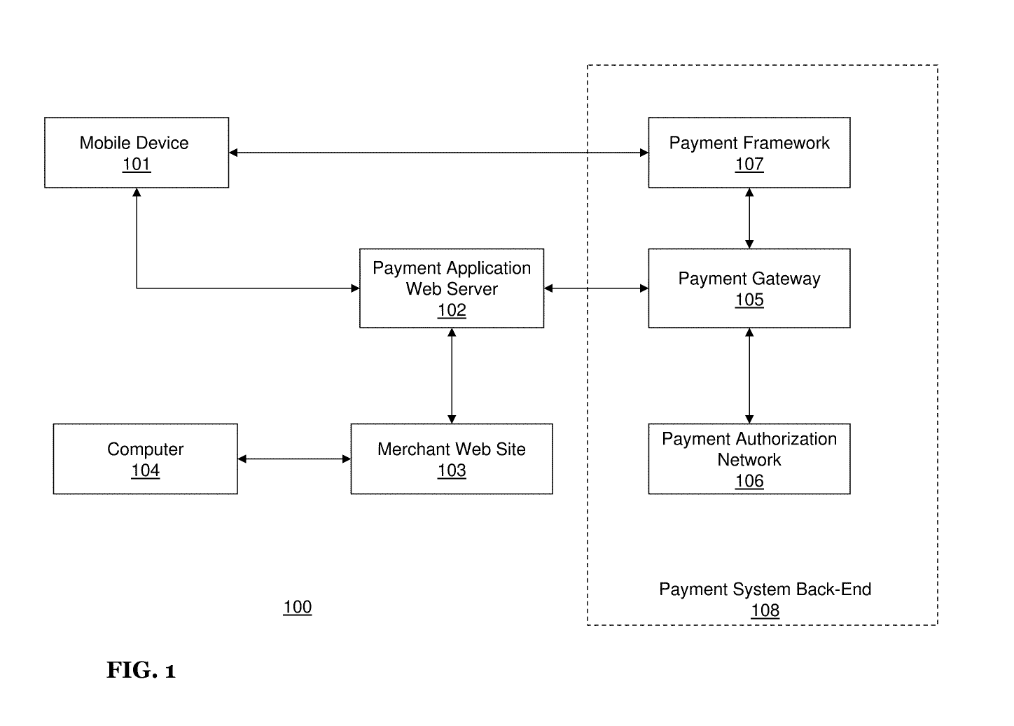

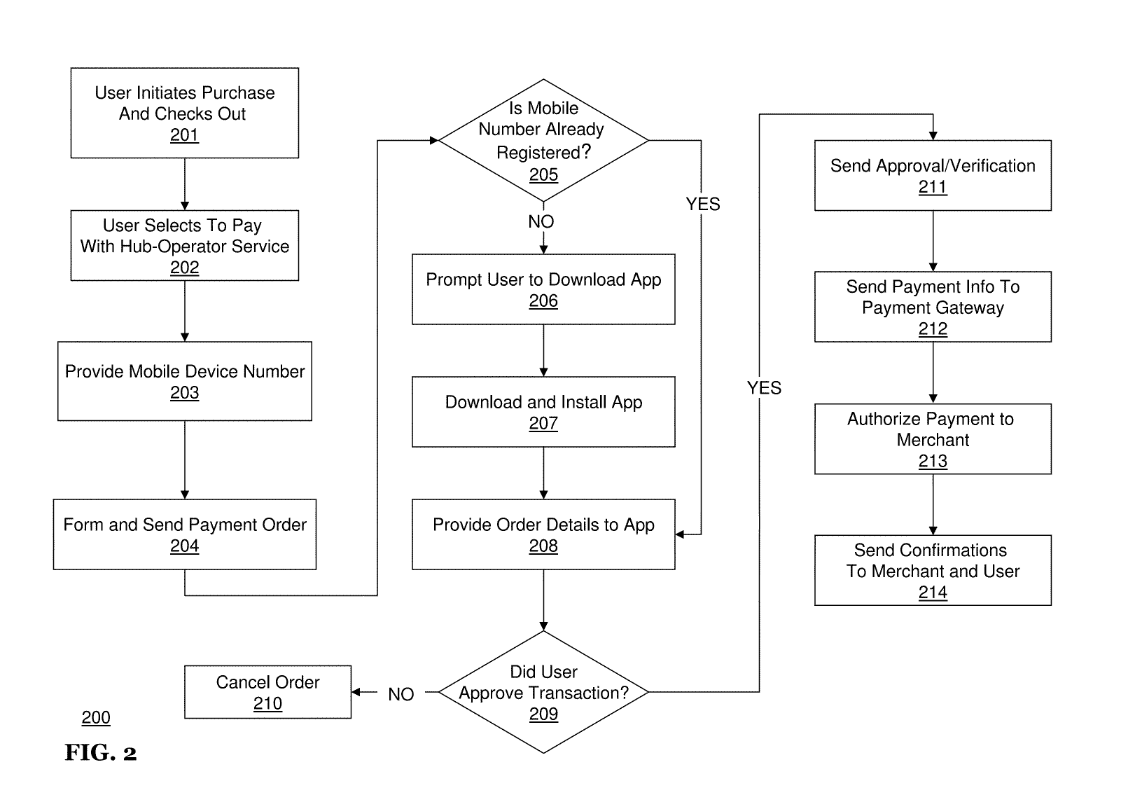

FIG. 1 is a simplified block diagram of a system 100 in accordance with one exemplary embodiment of the invention. FIG. 2 is a flowchart of an exemplary procedure 200 for using the system 100 of FIG. 1. In this embodiment, the user is an ordinary consumer employing a mobile telephone device 101—e.g., a smartphone—and a computer 104—e.g., a desktop, a laptop, or a tablet. The consumer uses the computer 104 to make a purchase from the merchant's website 103 and uses the mobile device 101, which is different from the computer 104, to verify the purchase and the user's identity. The merchant employs the website 103 to allow the user to order items from the merchant. The telephone number of the mobile device 101 may be used as a unique identifier for an account used by the user for e-commerce transactions. The consumer's own telephone number will presumably be relatively easy for the consumer to remember and/or access when paying for purchases. Note, however, that in different implementations, a different unique identifier—such as, for example, an email address—may be used by the user to identify the user's account.

The system 100 further comprises (i) a payment application web server 102 that communicates with the mobile device 101, the merchant website 103, and a payment system back-end 108. The mobile device 101 and the payment application web server 102 may communicate with various components of the payment system back-end 108. The payment system back-end 108 comprises various communication nodes—e.g., servers—for third-party financial entities involved in authenticating and transacting payments from the consumer to the merchant. The payment system back-end 108 includes (i) a payment gateway 105 that communicates with the payment application web server 102, (iii) a payment authorization network 106 that communicates with the payment gateway 105, and (iv) a payment framework 107 that communicates with the payment gateway 105 and the mobile device 101.

Some components of the payment system back-end 108 provide conventional payment-processing services. The payment framework 107 communicates (e.g., using the Apple Pay service or the like) with payment gateway 105 and payment application web server 102 to forward payment information for authorization and approval. The services of the payment framework 107 may be provided by, for example, the Apple PassKit framework, from Apple Inc. of Cupertino, California, which handles payments made using Apple Pay. The payment gateway 105 may be a conventional payment gateway that supports payment services such as Apple Pay and similar current (e.g., Google Wallet) and future products (e.g., an iteration of Google Wallet that supports biometrics). The services of the payment gateway 105 may be provided by, for example, Autherize.net, from CyberSource Corp. of San Francisco, California, which provides the infrastructure and security for transmission of financial transaction data between the consumer's bank, the merchant's bank, and related banking networks. The services of the payment authorization network 106—e.g., payment authorization—may be provided by, for example, a credit-card transaction processor such as, for example, First Data of Atlanta, Georgia.

Note that although various components of the system 100 are shown connected with direct communication paths, one or more of the communication paths may be routed through the Internet (not shown) or another communication network. Note that there may be additional communication links among various components of the system 100 that are not shown.

The payment application web server 102 may be considered the hub of the system 100 and may be operated by a hub operator such as, for example, Taply of New York, N.Y. The hub operator provides a mobile app for the mobile device 101 for use in this embodiment and provides transaction access and support to the merchant website 103.

The payment application web server 102 handles communication between the merchant's e-commerce website 103 and other components of system 100. The merchant registers on the payment application web server 102 via a web portal, which may be a specially designed web page for registration, to obtain a merchant account. The registration process may include the merchant providing data such as, for example, one or more of the merchant's name, email, business legal name, business alias (or doing business as (DBA) name), business type, employer identification number (EIN), Volume Threshold for amount of monthly credit-card processing, business address, phone number, title of company officer serving as a contact person, uniform resource locator (URL) Web address for the merchant's website, and internet protocol (IP) address of the merchant's website. Once registered, the merchant may integrate its e-commerce website 103 with the payment application web server 102, which may include using one or more content-management system (CMS)-modules, PHP (scripting language) APIs (application programming interfaces), REST (Representational State Transfer) APIs, etc. This may be accomplished, e.g., by downloading a plugin to the merchant's backend CMS portal or integration of suitable software code into the merchant's website.

The merchant website 103 may use hypertext transfer protocol (HTTP) verbs and a RESTful endpoint structure for communication with the payment application web server 102 and/or the user's computer 104. In communication between the merchant website 103 and the payment application web server 102, request and response payloads may be formatted in JavaScript Object Notation (JSON) format. The plugin and/or integrated software code in the merchant website 103 may include a unique key to uniquely identify each merchant to the payment application web server 102.

The payment application web server 102 comprises various e-commerce-transaction-supporting components such as, for example, a database, a back-end portal, a reporting portal, a mobile API module, a short message service (SMS) server, and a push notification server. Prior to opening the merchant website 103 to use by consumers in conjunction with the system 100, the merchant registers the merchant website 103 with the hub operator. In addition, the merchant provides, on the merchant website 103, a payment option for users to use during checkout, which includes using the hub-operator's service.

The hub operator may administer and control web portal settings for the payment application web server 102. These portal settings may include, for example, parameters for integrating the payment gateway 105 with the merchant's account on the payment application web server 102. The above-described web portal may provide an interface where an administrator for the hub operator may view relevant data in a graphical user interface.

The user initiates an e-commerce purchase transaction on the merchant website 103 using a web browser running on the computer 104 and, after selecting the desired items to purchase, checks out (step 201). One of the check-out options provided by the merchant on the merchant website 103 is using the hub-operator's service. The user selects to check out using the hub-operator's service (step 202), which may be done by clicking a correspondingly branded button on the merchant website 103. The user may then be prompted to provide the telephone number for the mobile device 101 (step 203). Note that, in some alternative implementations, the selection of check-out using the hub-operator app and/or the provision of the telephone number may be done automatically without requiring additional corresponding user input.

The merchant website 103 then generates a payment order and sends the order to the payment application web server 102 (step 204). The payment order includes the uniquely identifying number for the mobile device 101 as well as details of the order. Details of the order may include, for example, the merchant's name and/or logo, the items ordered (including item number, image, and/or description), their cost, tax amount, shipping fee, shipping destination, and shipment tracking information. The payment order may additionally include an order-expiration time—e.g., a time to live (TTL) parameter—that limits the time that the user has in which to approve the order before the order is canceled. The payment application web server 102 may receive the payment order by, for example, API and may store the order information in a database. After receiving the payment order, the payment application web server 102 determines whether the mobile device 101 already has the corresponding mobile application (“app”) and is registered with the payment application web server 102 (step 205). This may be done, for example, by sending a query to the mobile device 101.

If the mobile device 101 does not yet have the corresponding app, then the user is prompted to download the app (step 206). This may be done, for example, by providing to the mobile device 101 a link to download the mobile app. The link may be provided, for example, by SMS, to the telephone number of the mobile device 101. The user then downloads and installs the mobile application (step 207), where installation may include registering the app with the payment application web server 102 using the user's telephone number, an email address, and a password. No additional user information needs to be provided to the payment application web server 102. Indication of approval of the registration may then be transmitted by SMS code, where the payment application web server 102 sends an SMS to the mobile device 101 indicating the approved registration. The SMS may include a unique link for the user to click on the link in order to confirm the user's intent to register the mobile device 101. Alternatively, the SMS may include a unique numerical code for the user to enter into an appropriate field in the app to confirm the user's intent to register the mobile device 101.

If the user who selected “checkout by app” already has the mobile application installed and is registered with the payment application web server 102—whether following an affirmative determination in step 205 or following app installation in step 207—then the payment application web server 102 sends details regarding the user's pending order to the app on the user's mobile device 101 (step 208). The mobile app on the mobile device 101 may send to the payment application web server 102 geographic information indicating the location of the mobile device 101, which the payment application web server 102 may store in the database together with the corresponding order information. The location information may be used for security and fraud protection by, for example, comparing the location information with the registered user's address and flagging for review any determined anomalies. Also, the location information may be used by the service provider and/or shared with the merchant for remarketing or data-metrics purposes.

The mobile application provides a push notification to the user about the pending new order for the user's approval or rejection of the order (step 209). The user may approve the order (step 209) by, for example, (i) opening the mobile app, selecting an approval option, and verifying his or her identity using the app or (ii) swiping right on the pop-up notification and then verifying his or her identity. The approval option may be, for example, selecting to pay using Apple Pay. The user may, alternatively, reject the order (step 209) by, for example (i) opening the mobile app and selecting a rejection option or (ii) swiping left on the pop-up notification to reject the order, which cancels the order (step 210).

The user's verification of his or her identity may involve biometric verification including, for example, a fingerprint scan and/or an iris scan. The biometric verification may be performed by using infrastructure provided by, for example, Apple Pay. Following successful verification, the mobile application sends indication of the user's biometric verification to the payment application web server 102 and the payment framework 107 (step 211). The mobile application may send additional data to the payment application web server 102, such as, e.g., details of the user's pending order, which is useful in embodiments of the mobile app that enable the user to modify the order as part of the approval process (step 209).

The provision of data to the payment framework 107 (step 211) may include a pre-populated payment amount and a linking of the order to the payment framework 107. The payment application web server 102 sends data for processing the transaction to the payment gateway 105 (step 212) to connect the app on the mobile device 101 with the payment authorization network 106 to further process the purchase transaction, where the payment system back-end 108 then interacts with the payment application web server 102 to complete authorization of the purchase transaction (step 213).

The processing of the purchase transaction may include, for example, (i) automatic inclusion of transaction parameters in an API key provided by payment gateway 105, which are provisioned into the merchant's account on the payment application web server 102 to track transactions, (ii) coupling of the app on the mobile device 101 to the payment framework 107 to permit users of certain payment networks, such as credit card issuers and banks, to select their account on that payment network to fund payments.

After the payment application web server 102 receives authorization from the payment gateway 105, the payment application web server 102 notifies the merchant of the authorization by, for example, API, email, or another communications method (step 214). In one embodiment, only payment approval/denial information—not including the consumer's financial information—is communicated back to the merchant's e-commerce website 103. The merchant may then confirm the transaction (e.g., confirming the price and/or the availability of the goods/services being purchased) to the payment application web server 102 via API or another communications method, and the merchant may also confirm the transaction to the user by email or another communications method. The payment application web server 102 then confirms the transaction to the user by email or another communications method (step 214). The user may also receive a push notification with a confirmation of the transaction from the mobile application confirming that the payment for the purchase was successful.

Note that, in this embodiment, neither the payment application web server 102 nor the application running on the user's mobile device 101 stores or transmits any of the user's bank or payment card information. Rather, the payment application web server 102 provides order information and the mobile device 101 provides transaction authorization information to payment framework 107 for payment.

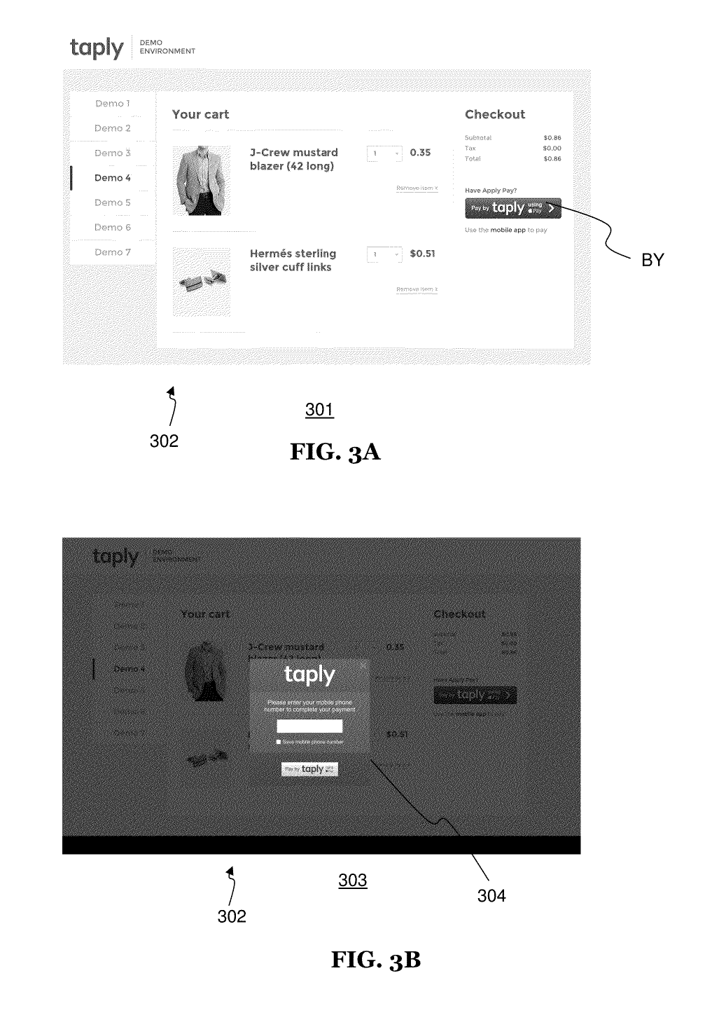

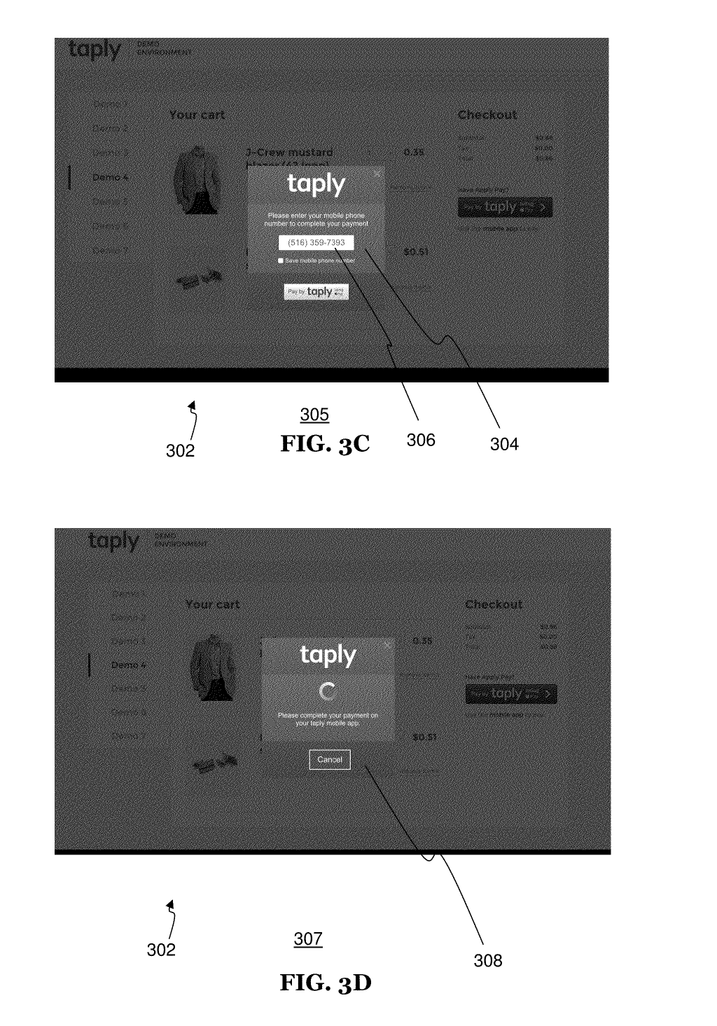

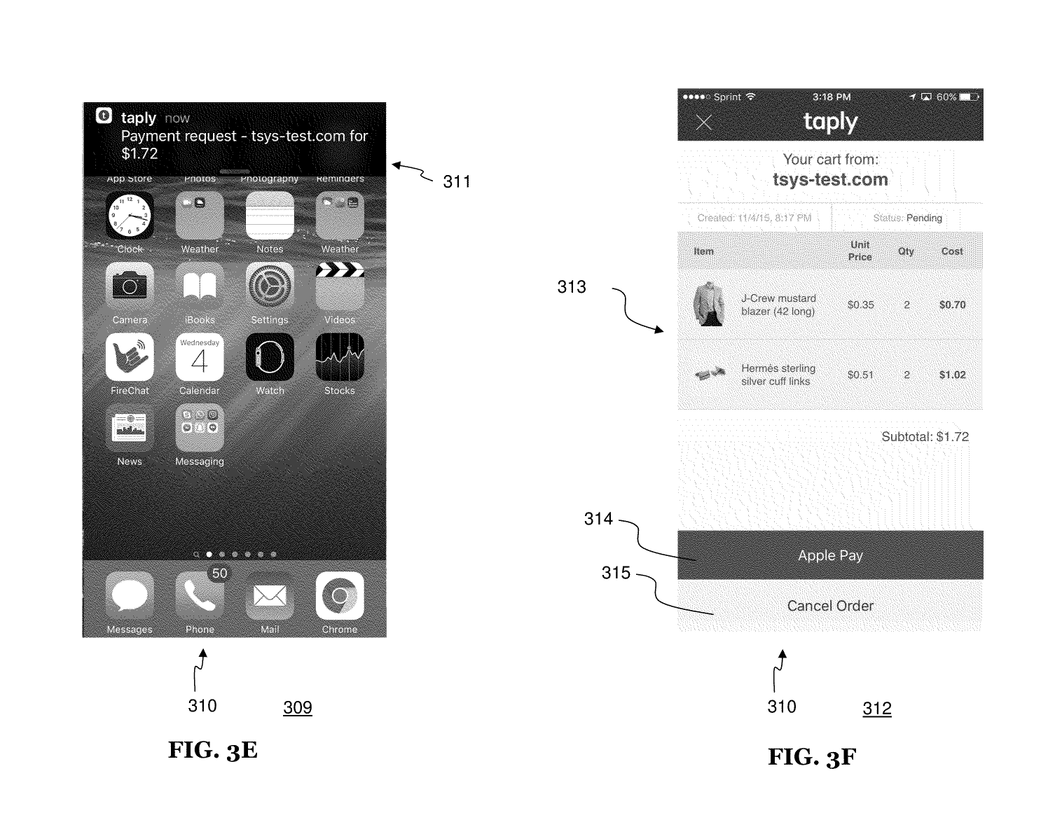

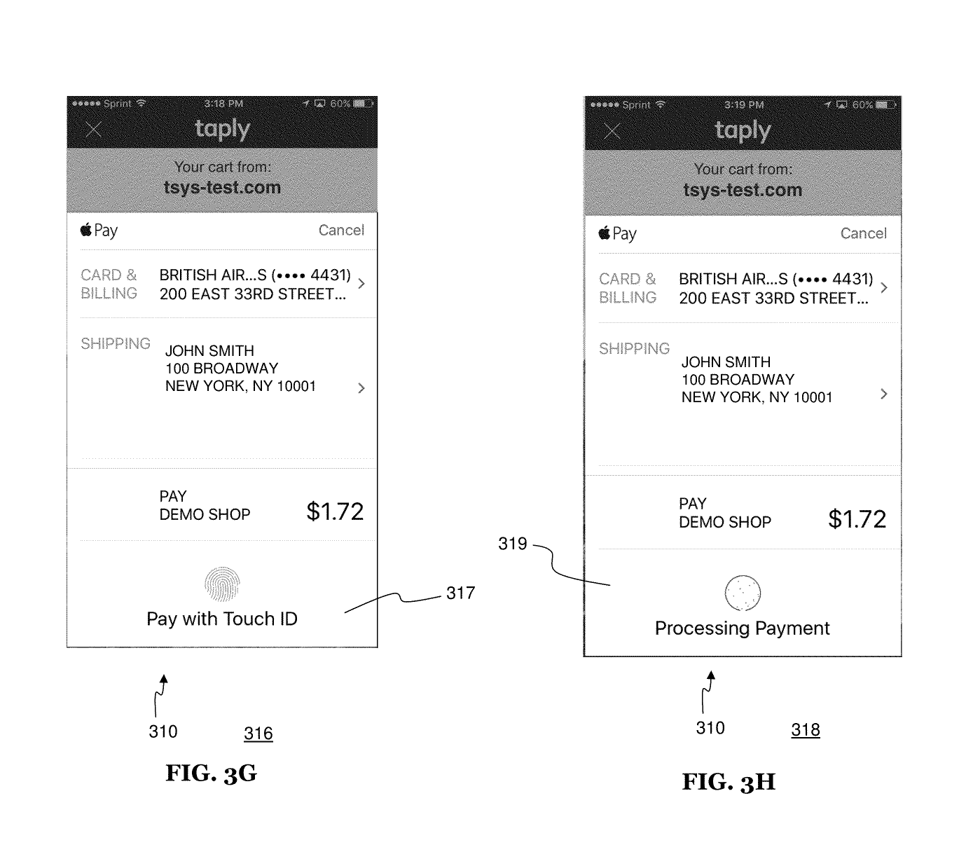

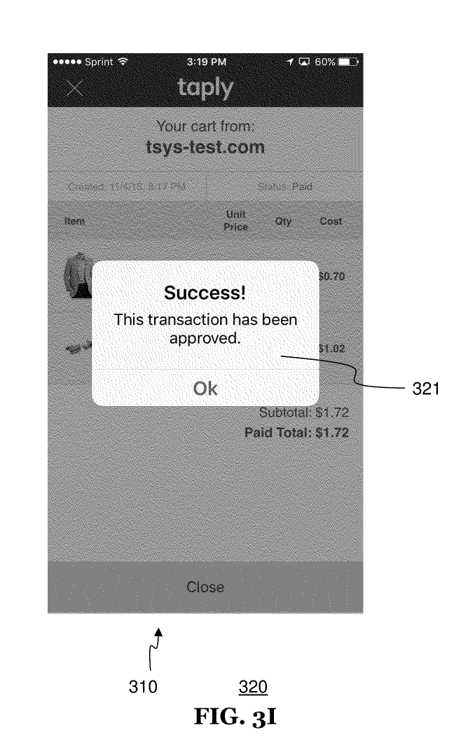

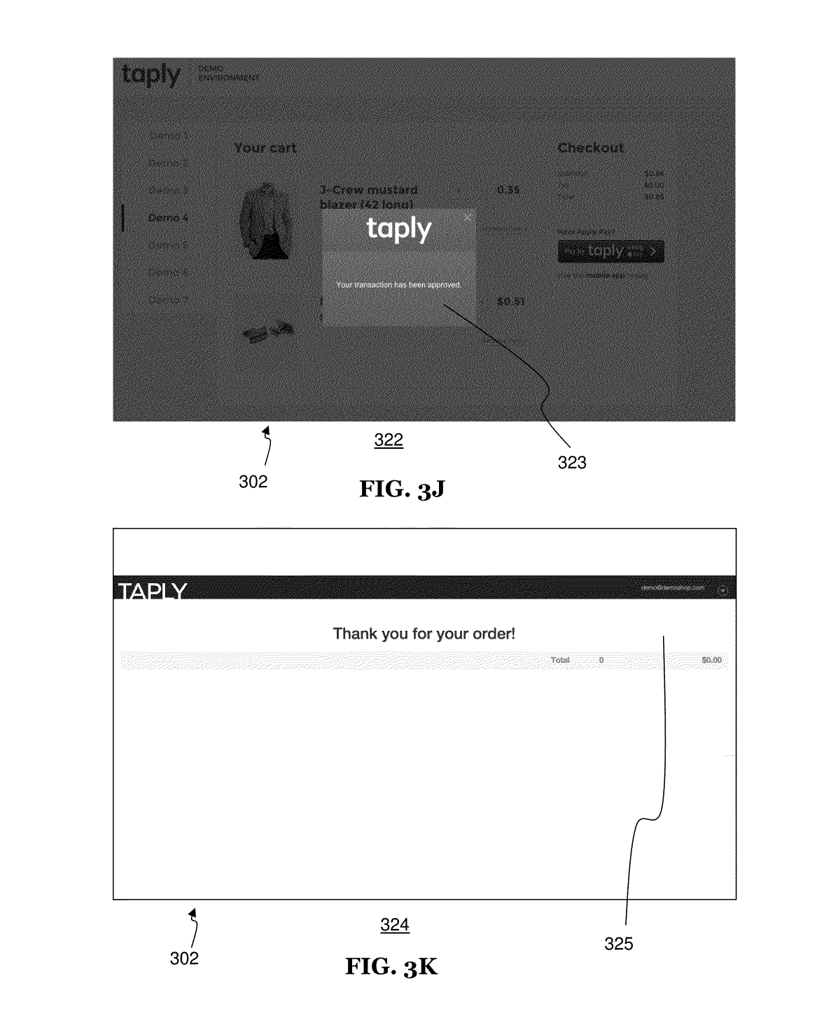

FIGS. 3A-3K are exemplary screenshots (i) from a monitor 302 of an exemplary computer 104 accessing an exemplary merchant website 103 of FIG. 1 and (ii) from a screen 310 of an exemplary mobile device 101 running an exemplary app. The screenshots of FIGS. 3A-3K illustrate several of the steps of the procedure 200 of FIG. 2.

Screenshot 301 of FIG. 3A shows the monitor 302 of the computer 104 during checkout from the merchant website 103 (step 201), including the branded hub-operator button BY. Screenshot 303 of FIG. 3B shows the monitor 302 after the user selected to pay using the hub-operator's service (step 202), including form 304 for providing the number for the mobile device 101. Screenshot 305 of FIG. 3C shows the monitor 302 after the user entered the mobile device's number 306 in the form 304 (step 203). Screenshot 307 of FIG. 3D shows the monitor 302 after the user affirmed the mobile-device number, including a notice 308 to complete the transaction on the mobile device 101.

Screenshot 309 of FIG. 3E shows the screen 310 of the mobile device 101 after the user received notification 311 of the order placed through the merchant's website 103. The notification is provided by the payment application web server 102, together with provision of the order details to the app (step 208). Screenshot 312 of FIG. 3F shows the screen 310, after the user selected the notification 311 of FIG. 3E, and includes the order details 313, approval button 314, and cancellation button 315. Screenshot 316 of FIG. 3G shows screen 310 after the user approved the transaction (step 209) by selecting approval button 314 of FIG. 3F, including option 317 to pay with Touch ID, which includes fingerprint verification of the user. Screenshot 318 of FIG. 3H shows the screen 310 after the user selected option 317 of FIG. 3G and successfully passed the fingerprint verification. Screenshot 318 includes notification 319 that the payment is being processed (steps 211, 212, and 213). Screenshot 320 of FIG. 3I shows the screen 310 after the payment has been authorized (step 213) and includes an approval notification 321.

Screenshot 322 of FIG. 3J shows the monitor 302 of the computer 104 after the payment has been authorized (step 213) and includes an approval notification 323. Screenshot 324 of FIG. 3K shows the monitor 302 after the confirmation email 325 has been sent to the user (step 214).

Note that using a unique identifier, such as the user's (e.g., 10-digit) mobile telephone number, enables the user to check out of an e-commerce website by simply entering his or her phone number, with no username/password required. The system 100 provides a convenient method for e-commerce websites to use payment services, such as Apple Pay, to enable users to make online purchases.

Although a network signal is employed to complete the transaction, an offline mode may also be available in some embodiments, which may permit later completion of a transaction and receipt of order confirmation. In this scenario, if the network connection is not restored before a predetermined time limit expires, then the corresponding order(s) will expire.

In alternative embodiments, the computer 104 may be a cash register or another mobile or non-mobile device capable of executing an http/html or other Internet browser. In one alternative embodiment, the computer 104 is a specialized device, such as a cash register, which employs hardware and/or software other than a browser and is capable of interacting with a merchant e-commerce website 103 or other merchant e-commerce transaction server to initiate a purchase transaction (e.g., a cash register equipped with a dedicated “Apple Pay” or “Pay with app” button for selecting a purchase method). In one alternative embodiment, the computer 104 is an Apple TV, or other tvOS-compatible device, running an application allowing the user to select items for purchase from the merchant and then select to pay using the hub-operator service during check out.

Note that, although the implementations described include exemplary items purchased using system 100 that are products, the system 100 may also provide for the purchase of items that are services or otherwise not tangible products.

In some embodiments, payments may be made at times and points of sale other than merchant web-site checkout processes. For example, in one embodiment, a merchant can send an invoice to a user containing a link to initiate a payment via the mobile application and payment application web server 102.

Payment application web server 102 may provide additional functionality in alternative embodiments. For example, in one embodiment, payment application web server 102 may provide chat functionality between merchants and current or prospective purchasing users. In some embodiments, payment application web server 102 enables one or more of the following features: purchase history, order tracking, content-management system (CMS) plugins for large shopping carts (such as by using e-commerce software, e.g., software provided by Magento, Shopify, Volusion, or Zencart), a merchant portal for viewing orders on the web, and an administrative portal for configuring accounts and viewing the hierarchy of merchant portals, SMS spam protection (e.g., not permitting more than 3 different phone numbers from one IP address within 1 hour), storage of geolocation data from the mobile application with each transaction in a database of web server 102, and an online merchant application that appears in the merchant portal and connects to third-party payment services or other services, e.g., payment services provided by Vantiv, FirstData, TSYS, or the DocuSign verification service.

Although embodiments have been described herein in which biometric data and techniques are used to verify the identity of the user, it should be understood that, in alternative embodiments, other user-verification techniques may be used in addition to the biometric verification. For example, in one embodiment, a verifying the user's identity further involves using a password, encryption key, data file, hardware token, or other non-biometric scheme.

It should be understood that appropriate hardware, software, or a combination of both hardware and software is provided to effect the processing described above, in the various embodiments of the disclosure. It should further be recognized that a particular embodiment might support one or more of the modes of operation described herein, but not necessarily all of these modes of operation.

Components of a system consistent with embodiments of the disclosure may include mobile and non-mobile devices. Mobile devices that may be employed in embodiments of the present disclosure include personal digital assistant (PDA) style computers, e.g., as manufactured by Apple Computer, Inc. of Cupertino, Calif., or Palm, Inc., of Santa Clara, Calif., and other computers running the Android, Symbian, RIM Blackberry, Palm webOS, or iOS operating systems, Windows CETM handheld computers, or other handheld computers (possibly including a wireless modem), as well as wireless, cellular, or mobile telephones (including GSM phones, J2ME and WAP-enabled phones, Internet-enabled phones, and data-capable smart phones), one- and two-way paging and messaging devices, laptop computers, etc. Other telephonic network technologies that may be used as potential service channels in a system consistent with embodiments of the disclosure include 2.5G cellular network technologies such as GPRS and EDGE, as well as 3G technologies such as CDMA1xRTT and WCDMA2000, and 4G technologies. Although mobile devices may be used in embodiments of the disclosure, non-mobile communications devices are also contemplated by embodiments of the disclosure, including personal computers, Internet appliances, set-top boxes, landline telephones, etc. Clients may also include a PC that supports Apple Macintosh™, Microsoft Windows 95/98/NT/ME/CE/2000/XP/Vista/7™, a UNIX Motif workstation platform, or other computer capable of TCP/IP or other network-based interaction. In one embodiment, no software other than a web browser may be required on the client platform.

In one embodiment, source code may be written in an object-oriented programming language using relational databases. Such an embodiment may include the use of programming languages such as C++ and toolsets such as Microsoft's .Net™ framework. Other programming languages that may be used in constructing a system according to embodiments of the present disclosure include Java, HTML, Perl, UNIX shell scripting, assembly language, Fortran, Pascal, Visual Basic, and QuickBasic. Those skilled in the art will recognize that embodiments of the present disclosure may be implemented in hardware, software, or a combination of hardware and software.

Accordingly, the terms “computer” or “system,” as used herein, should be understood to mean a combination of hardware and software components including at least one machine having a processor with appropriate instructions for controlling the processor. The singular terms “computer” or “system” should also be understood to refer to multiple hardware devices acting in concert with one another, e.g., multiple personal computers in a network; one or more personal computers in conjunction with one or more other devices, such as a router, hub, packet-inspection appliance, or firewall; a residential gateway coupled with a set-top box and a television; a network server coupled to a PC; a mobile phone coupled to a wireless hub; and the like. The term “processor” should be construed to include multiple processors operating in concert with one another.

It should also be appreciated from the outset that one or more of the functional components may alternatively be constructed out of custom, dedicated electronic hardware and/or software, without departing from the present invention. Thus, embodiments of the invention are intended to cover all such alternatives, modifications, and equivalents as may be included within the spirit and broad scope of the disclosure.

It should be understood that various changes in the details, materials, and arrangements of the parts which have been described and illustrated in order to explain the nature of this disclosure may be made by those skilled in the art without departing from the scope of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the disclosure.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

Although the disclosure has been set forth in terms of the exemplary embodiments described herein and illustrated in the attached drawings, it is to be understood that such disclosure is purely illustrative and is not to be interpreted as limiting. Consequently, various alterations, modifications, and/or alternative embodiments and applications may be suggested to those skilled in the art after having read this disclosure. Accordingly, it is intended that the disclosure be interpreted as encompassing all alterations, modifications, or alternative embodiments and applications as fall within the true spirit and scope of this disclosure.

We claim:

1. A method for a payment application web server, the method comprising:
allowing a user to select, using a first computer device, a set of one or more items for purchase from a merchant;
allowing the user to select, using the first computer device, to pay the merchant using a hub-operator service associated with the payment application web server;
receiving, by the payment application web server, first information identifying the set of one or more items, the merchant, and a unique identifier associated with the user;
providing, by the payment application web server, to a mobile device of the user, using the unique identifier, second information identifying the set of one or more items, the merchant, and a transaction to pay the merchant for the set of one or more items using the hub-operator service;
prompting the user to approve the transaction using the mobile device;
prompting the user to provide biometric verification of the user's identity;
providing, by the payment application web server, to a payment system back-end, third information identifying the transaction, for authorization of the transaction by the payment system back-end; and
providing, by the payment application web server, notification of the authorization of the transaction to the mobile device, the computer, and the merchant.

2. The method of claim 1, wherein the first information is received by the payment application web server from the first computer device.

3. The method of claim 1, wherein:
the mobile device has a telephone number; and
the unique identifier is the telephone number of the mobile device.

4. The method of claim 1, wherein the unique identifier is an email address for the user that is associated with the mobile device.

5. The method of claim 1, wherein the mobile device is different from the first computer device.

6. The method of claim 1, wherein the payment system back-end supports at least one digital-wallet service.

7. The method of claim 1, wherein the one or more items for purchase from the merchant are selected from a website operated by the merchant.

8. The method of claim 1, further comprising, prior to the receiving step, prompting the user to provide the unique identifier.

9. The method of claim 1, further comprising, prior to the receiving step, automatically acquiring the unique identifier without requiring user input of the unique identifier.

10. The method of claim 1, further comprising, prior to providing the second information to the mobile device:
making a determination whether the mobile device has a corresponding application installed; and
if the determination is negative, then prompting the user to install the corresponding application on the mobile device.

11. The method of claim 10, wherein the prompting step is performed by the corresponding application.

12. The method of claim 1, wherein the steps of providing the third information and providing the notification of the authorization are performed only if the user approved the transaction in response to the prompting step.

13. The method of claim 12, further comprising, if the user approved the transaction in response to the prompting step, then requiring the user to verify the user's identity before proceeding.

14. The method of claim 1, wherein the prompting step includes allowing the user to modify the set of one or more items for purchase.

15. The method of claim 1, wherein:
the user has personal financial information used by the payment system back-end for the authorization of the transaction by the payment system back-end;
the personal financial information is not provided to the merchant; and
the personal financial information is not provided to the payment application web server.

16. The method of claim 1, wherein:
the second information includes an order-expiration time parameter setting a time limit; and
the steps of providing the third information and the notification of the authorization are performed only if the user approved the transaction within the time limit.

17. A payment application web server adapted to:
receive notification that a user selected, using a first computer device, a set of one or more items for purchase from a merchant;
receive notification that the user selected, using the first computer device, to pay the merchant using a hub-operator service associated with the payment application web server;
receive first information identifying the set of one or more items, the merchant, and a unique identifier associated with the user;
provide to a mobile device of the user, using the unique identifier, second information identifying the set of one or more items, the merchant, and a transaction to pay the merchant for the set of one or more items using the hub-operator service;
receive notification that the user approved the transaction using the mobile device;
provide to a payment system back-end, third information identifying the transaction, for authorization of the transaction by the payment system back-end; and
provide notification of the authorization of the transaction to the mobile device, the computer, and the merchant.

18. The server of claim 17, wherein:
the user has personal financial information used by the payment system back-end for the authorization of the transaction by the payment system back-end;
the personal financial information is not provided to the merchant; and
the personal financial information is not provided to the payment application web server.

19. A computer server comprising:
means for receiving notification that a user selected, using a first computer device, a set of one or more items for purchase from a merchant;
means for receiving notification that the user selected, using the first computer device, to pay the merchant using a hub-operator service associated with the payment application web server;
means for receiving first information identifying the set of one or more items, the merchant, and a unique identifier associated with the user;
means for providing to a mobile device of the user, using the unique identifier, second information identifying the set of one or more items, the merchant, and a transaction to pay the merchant for the set of one or more items using the hub-operator service;
means for receiving notification that the user approved the transaction using the mobile device;
means for providing to a payment system back-end, third information identifying the transaction, for authorization of the transaction by the payment system back-end; and
means for providing notification of the authorization of the transaction to the mobile device, the computer, and the merchant.
